(19) United States
(12) Patent Application Publication
(10) Pub. No.: US 2006/0150093 A1
(43) Pub. Date: Jul. 6, 2006

(54) Page-break creating method for printing document

(75) Inventor: Chien Ming Chen, Taipei (TW)

Correspondence Address: BACON & THOMAS, PLLC, 625 SLATERS LANE, FOURTH FLOOR, ALEXANDRIA, VA, 22314, US

(73) Assignee: TECO IMAGE SYSTEMS CO., LTD, Taipei (TW)

(21) Appl. No.: 11/118,364

(22) Filed: May 2, 2005

(30) Foreign Application Priority Data
Dec. 30, 2004 (TW) 093141479

(51) Int. Cl. G06F 17/21; G06F 3/12

(52) U.S. Cl. 715/518; 715/525; 715/527; 358/1.15

(57) ABSTRACT

A page-break creating method for use with a computer system is disclosed. The computer system is in communication with a printing device. After a document to be printed is selected, in response to a print command from the computer system, it is discriminated whether there is at least one graph included in image data of the document. Then, the region of the at least one graph is located if there is at least one graph included in the image data of the document. Then, the region of at least one text paragraph included in the image data of the document is located. Afterward, a page-break setting is created according to the regions of the at least one graph and the at least one text paragraph by inserting a page break in the image data of the document such that no graph or text paragraph is divided into separable one on different pages.

### FIELD OF THE INVENTION

The present invention relates to a page-break creating method, and more particularly to a page-break creating method suitable for printing a document.

### BACKGROUND OF THE INVENTION

With increasing power of personal computers, a diversity of peripheral devices can be employed with the personal computers to achieve various purposes. The diverse peripherals, for example printers, fax machines, copy machines and scanners, however, occupy lots of space. A multifunction peripheral (MFP) having multiple functions in one structural unit is thus developed.

When a multifunction peripheral is used to print a document having a length more than one page and containing a graph, if the computer system in communication with the multifunction peripheral has an automatic page-break setting function, the graph included in the document such as a Microsoft Word document, may not be printed on two separable pages.

However, some documents such as a web-page document fail to be edited by the computer system. As shown in FIG. 1, in response to a print command asserted from the computer system, several page breaks are created in the raw data of the web-page document 10 according to the paper size. Afterward, the encoded data are transmitted to a multifunction peripheral in a Printer Control Language (PCL) or Graphics Device Interface (GDI). Since the length between two adjacent page breaks are identical to the preset length of the unitary page, some problems may occur. For example, the graph 11 included in the document 10 is printed on the first and second pages. In addition, one portion of the text paragraph 12 is printed on the third page but the other portion of the text paragraph 12 is printed on the fourth page. Under this circumstance, this web-page document 10 is not well typeset, and thus the printed document is not pleasing to eye.

Consequently, because of the technical defects of described above, the applicant keeps on carving unflaggingly through wholehearted experience and research to develop the present invention, which can effectively improve the problems described above.

### SUMMARY OF THE INVENTION

An object of the present invention is to provide a page-break creating method for use with a computer system so as to assure that no graph or text paragraph is printed on different pages.

In accordance with a first aspect of the present invention, there is provided a page-break creating method for use with a computer system. The computer system is in communication with a printing device. After a document to be printed is selected, in response to a print command from the computer system, it is discriminated whether there is at least one graph included in image data of the document. Then, the region of the at least one graph is located if there is at least one graph included in the image data of the document. Then, the region of at least one text paragraph included in the image data of the document is located. Afterward, a page-break setting is created according to the regions of the at least one graph and the at least one text paragraph by inserting a page break in the image data of the document such that no graph or text paragraph is divided into separable one on different pages.

Preferably, the printing device is included in a multifunction peripheral.

Preferably, the document is a web-page document.

In an embodiment, the page-break creating method further comprises a step of detecting Gray scale of the image data of the document so as to discriminate whether there is at least one graph included in the image data of the document.

In an embodiment, the page-break creating method further comprises a step of performing a Gray scale before the step of detecting Gray scale if the image data are multicolored.

In an embodiment, the page-break creating method further comprises a step of reducing resolution of the image data when the discriminating result shows there is at least one graph included in image data of the document.

In an embodiment, the image data with reduced resolution contain a plurality of regular grids.

In an embodiment, the page-break creating method further comprises a step of analyzing the plurality of regular grids by wavelet transformation or entropy encoding means, thereby locating the region of the at least one graph.

In an embodiment, the page-break creating method further comprises a step of performing a binary analysis on the image data of the document, thereby locating the region of at least one text paragraph included in the image data of the document.

In an embodiment, the page-break creating method further comprises steps of obtaining a vertical projection profile from the binary analysis, and inserting a page break in the image data of the document according to the vertical projection profile.

In an embodiment, the page-break creating method further comprises steps of performing an encoding operation of the page-break setting, and transmitting the encoded data to the printing device.

In an embodiment, the page-break creating method further comprises steps of decoding the encoded data, and printing the document by the printing device according to the page-break setting.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a web-page document processed according to a conventional page-break creating method;

FIG. 2 is a flowchart of a page-break creating method according to a preferred embodiment of the present invention;

FIG. 3 schematically illustrates a web-page document processed according to the page-break creating method of the present invention;

FIG. 4 is a detailed flowchart illustrating the steps of locating the regions of the graph and the text paragraph and properly creating the page-break setting according to the page-break creating method of the present invention;

FIG. 5(a) is a schematic view illustrating multicolored image data of a document after a Gray scale;

FIG. 5(b) is a schematic Gray scale diagram showing that no graph is included in the image data;

FIG. 5(c) is a schematic Gray scale diagram of the document of FIG. 5(a);

FIG. 5(d) is a schematic view of the document of FIG. 5(a) with reduced resolution; and

FIG. 5(e) is a schematic vertical projection profile of the document of FIG. 5(a).

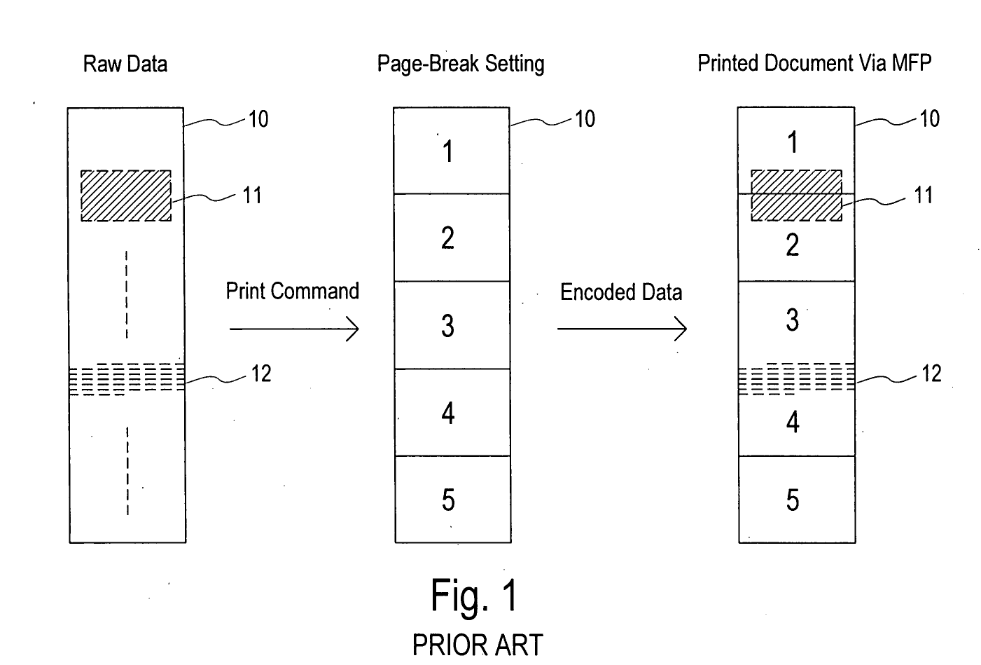

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

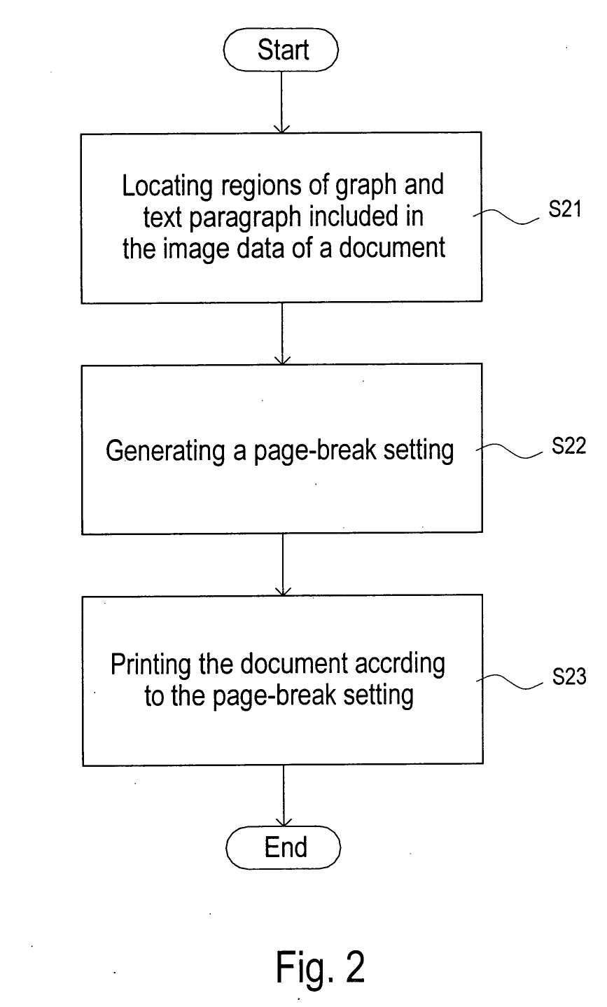

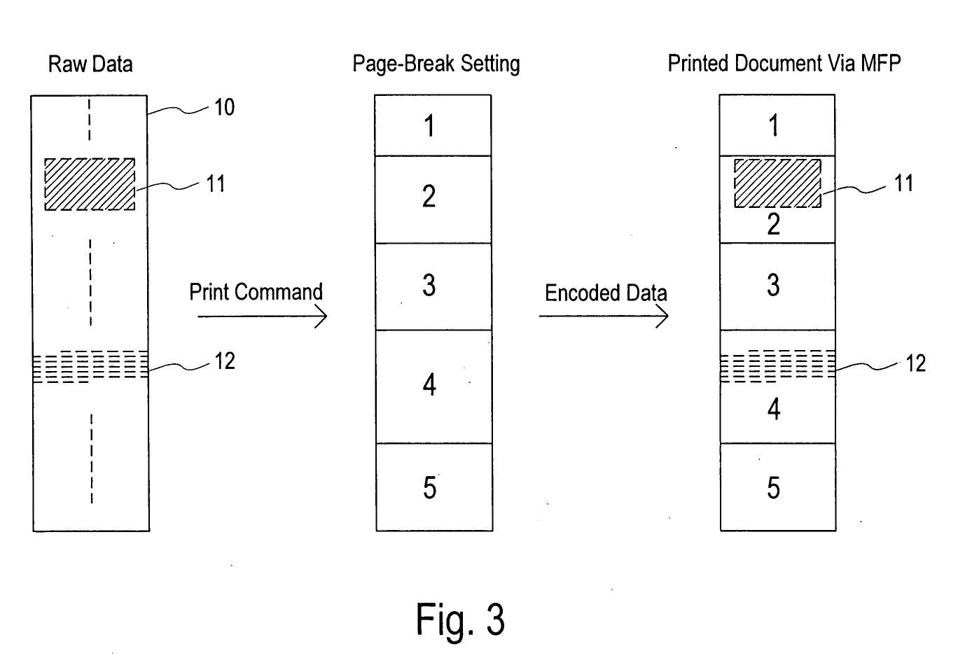

Referring to FIG. 2, a flowchart of a page-break creating method according to a preferred embodiment of the present invention is shown. The page-break creating method of the present invention can be applied to a multifunction peripheral (MFP) in communication to a computer system. After a document to be printed is selected, in response to a print command asserted from the computer system, it is discriminated whether there is at least one graph included in image data of the document. An example of the document is a web-page document, which fails to be previously edited by the computer. If the discriminating result shows that there is any graph, the regions of the graph and the text paragraph included in the image data of the document should be located (step S21). According to the regions of the graph and the text paragraph, a page-break setting is created so as to properly create page breaks in the image data of the document. Under this circumstance, no graph or text paragraph is divided into separable one on different pages (step S22). After the page-break setting is implemented, an encoding operation of the page-break setting is performed, and the encoded data are transmitted to the multifunction peripheral. Meanwhile, the encoded data are decoded by the multifunction peripheral, thereby printing the document that has been suitably typeset (step S23). The method of the present invention can assure that no graph or text paragraph is printed on different pages. It is noted, however, the length between two arbitrary page breaks may be different, as can be seen in FIG. 3.

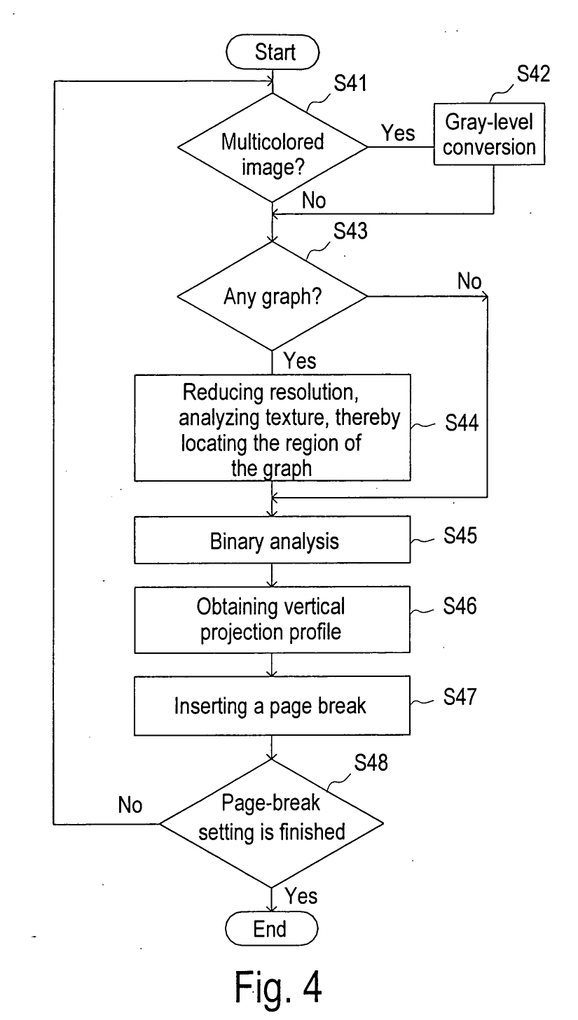

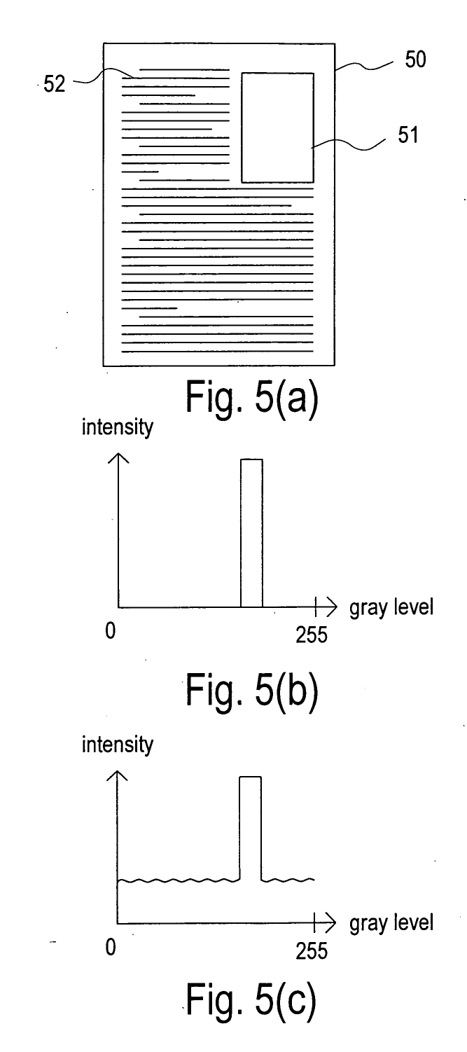

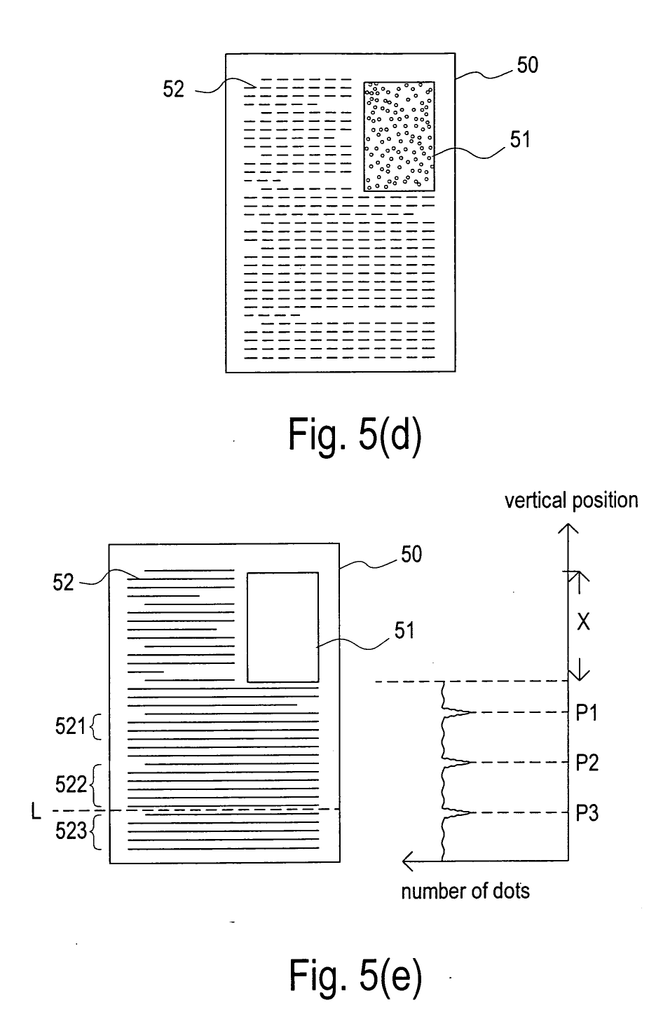

For further understanding the present invention, the steps of locating the regions of the graph and the text paragraph (step S21) and properly creating the page-break setting (step S22) are illustrated with reference to the flowchart of FIG. 4 and the schematic diagrams of FIG. 5.

After a document to be printed is selected, in response to a print command asserted from the computer system, it is discriminated whether the image data of the document are multicolored (step S41). If the discriminating result shows that the image data of the document are multicolored, the image data should be converted into gray levels (step S42). Otherwise, the step S42 is omitted when there is no multicolored image data. For example, if the multicolored image data of the document is in a RGB format, the image data may be converted into gray levels according to the equation: F(x, y)=0.3×R(x, y)+0.59×G(x, y)+0.11×B(x, y). The multicolored image data after the Gray scale is illustrated in FIG. 5(a), in which the document 50 comprises a graphic portion 51 and a text portion 52. If the Gray scale diagram shows that all gray levels are almost concentrated at a certain value, as shown in FIG. 5(b), it will be considered that no graph is included in the image data because the concentrated gray level is too sharp. Otherwise, if the Gray scale diagram shows that the gray levels are uniformly distributed, as shown in FIG. 5(c), it will be considered that there is at least a graph included in the image data because the gray level is smoother.

If there is a graph included in the image data of the document from the discriminating result (step S43), the resolution of image data of the document should be reduced such that the text portion 52 of the document 50 contains a plurality of regular grids, as shown in FIG. 5(d). Then, the texture of these regular grids is analyzed by wavelet transformation or entropy encoding means, thereby locating the graph portion 51 of the document 50 (step S44).

Subsequently, a binary analysis is performed (step S45). Since the graph portion 51 should not be divided into separable one, the binary analysis is performed on the text portion 52 following the graph portion 51.

Then, a vertical projection profile is obtained from the binary analysis (step S46). As shown in FIG. 5(e), there are three troughs p1, p2 and p3 in the projection profile. Each trough indicates a beginning of individual text paragraph. In other words, there are two complete text paragraphs 521 and 522 and one incomplete text paragraph 523.

Then, a page-break setting is created according to the binary analysis (step S47). In order to assure that no text paragraph is divided into separable one, a page break L is inserted between the text paragraphs 522 and 523 such that the incomplete text paragraph 523 will be printed on next page.

The above steps will be continued until all the image data of the document are properly divided into several pages ready to be printed (step S48).

From the above description, since no graph or text paragraph is printed on different pages, the suitably typeset web-page document is pleasing to eye.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A page-break creating method for use with a computer system, said computer system being in communication with a printing device, said method comprising steps of:
selecting a document to be printed;
discriminating whether there is at least one graph included in image data of said document in response to a print command from said computer system;
locating the region of said at least one graph on a condition that there is at least one graph included in said image data of said document;
locating the region of at least one text paragraph included in said image data of said document; and
creating a page-break setting according to the regions of said at least one graph and said at least one text paragraph by inserting a page break in said image data of said document such that no graph or text paragraph is divided into separable one on different pages.

2. The method according to claim 1 wherein said printing device is included in a multifinction peripheral.

3. The method according to claim 1 wherein said document is a web-page document.

4. The method according to claim 1 further comprising a step of detecting Gray scale of said image data of said document so as to discriminate whether there is at least one graph included in image data of said document.

5. The method according to claim 4 further comprising a step of performing a Gray scale before said step of detecting Gray scale if said image data are multicolored.

6. The method according to claim 4 further comprising a step of reducing resolution of said image data when the discriminating result shows there is at least one graph included in image data of said document.

7. The method according to claim 6 wherein said image data with reduced resolution contain a plurality of regular grids.

8. The method according to claim 7 further comprising a step of analyzing said plurality of regular grids by wavelet transformation or entropy encoding means, thereby locating the region of said at least one graph.

9. The method according to claim 8 further comprising a step of performing a binary analysis on said image data of said document, thereby locating the region of said at least one text paragraph included in said image data of said document.

10. The method according to claim 9 further comprising the steps of:
obtaining a vertical projection profile from said binary analysis; and
inserting a page break in said image data of said document according to said vertical projection profile.

11. The method according to claim 1 further comprising steps of:
performing an encoding operation of said page-break setting; and
transmitting said encoded data to said printing device.

12. The method according to claim 11 further comprising steps of:
decoding said encoded data; and
printing said document by said printing device according to said page-break setting.
